(19) United States
(12) Patent Application Publication
(10) Pub. No.: US 2011/0035297 A1
(43) Pub. Date: Feb. 10, 2011

(54) AUTOMATED TRADING PLATFORM AND METHOD

(76) Inventor: CHIA-LIN CHAO, Taipei City (TW)

Correspondence Address: Dr. BANGER SHIA;Patent Office of Bang Shia, 102 Lindencrest Ct, Sugar Land, TX, 77479-5201, US

(21) Appl. No.: 12/846,762

(22) Filed: Jul. 29, 2010

Related U.S. Application Data
(60) Provisional application No. 61/232,041, filed on Aug. 7, 2009.

(51) Int. Cl. G06Q 30/00; G06Q 10/00

(52) U.S. Cl. 705/27.1

(57) ABSTRACT

The invention provides an automated trading system and method for servicing providers and retailers to carry out trading activities and simplifying trading processes. According to the invention, the automated trading platform includes a database, a registration processing module, a product parameter generation module, a logistic management module, a price calculation module, a product information display module, a transaction processing module, and an information statistic module. The automated trading platform is capable of calculating various payable and acquired amounts by different roles corresponding to the product at different time points during different sales cycles, so as to balance the benefits of different roles.

### BACKGROUND OF THE INVENTION

1. Field of the Invention

The present invention relates to an automated trading platform and method and, more particularly, to an automated trading platform and method for servicing and facilitating providers and retailers to carry out trading activities and simplifying trading processes.

2. Description of the Prior Art

In recent years, pervasive internet applications and information spread make the world become an informational-integrated global village. Almost everyone is capable of logging on the internet to retrieve information, buy stuff and sell products. Thus the profits of the manufacturers and the traders are significantly reduced.

Generally, as a provider, e.g. a manufacturer or a trader, is going to sell products from one country to another, the products have to pass through exporters, importers, wholesalers, distributors, and the physical channels or Internet sellers to be sent to the end-consumer. Such various intermediary costs hugely squeeze the profits of the provider.

Typically, the gross margin gained by an average manufacturer is less than thirty percent and the net profit is less than five percent. The shipment usually requires backups for defective products to meet L/C stipulated quantity, thus make the inevitable stocks and excess materials hold by the provider. The stocks are inevitable but cause problems hard to solve.

The providers often have innovative thinking and technologies. But they did not have the method or capability to testify if their ideas are acceptable to the market. The providers usually face the difficulties such as: They are unable to control the market price and the changing relation between the quantity and the selling price of a product; they have to develop the next generation products by experiences and intuitions since there is no market information for assistance; they frequently have to use expensive air shipping to make up the market requirement variations; the information communication between them and the end-customer is indirect and complicated; etc.

In the other hand, along with the rapid Internet information development, traders have to retention the customers and prevent them from direct contact with the providers such as manufacturers. The traders can only sell their service and innovation. They have franchises of diverse products, but their scales are limited.

The traders frequently have to use air shipping instead of ocean shipping to compensate the shipping time reduction. Meanwhile, they have to worry about uncertainties such as the L/C requirement, delayed payment or even the bad debt of the foreign importers, proper price for market, and displeasure of other unsatisfied customers, etc. The traders have to face problems such as inability to control the market price; inability to control the changing relationship between the quantity and the selling price of a product, customs declaration, logistic and import/export issues; too small ordered quantity; insufficient fund for logistic, cash and cost flow; and even exchange losses. Not mentioned that they frequently have to use expensive air shipping to make up the market variations. Similarly, the information communication between them and the end-customer is indirect and complicated.

At present, a variety of retailers such as Internet sellers and physical store operators are not serviced by dedicated traders. Some of these retailers are competitive in scale compared with local agencies or even regional importer. But the traders sometimes do not appreciate the innovative ideas of the retailers due to their young ages. Some other Internet sellers are small in scale, but they are very diligent and professional in their interested fields. But they have only small sales quantity and very limited profits, along with high purchasing cost pressure. Therefore they dare not to hold large stocks even they are capable of sell large quantity of products. The Internet seller or retailers are facing problems such as that they can not acquire low cost products directly from the manufacturers or from overseas providers; they have to carry large stock stress or relax the stock stress by using expensive air shipping or wait for a long time.

Therefore, there is a need for an automated trading platform and method to solve aforesaid problems.

### SUMMARY OF THE INVENTION

A scope of the invention is to provide an automated trading platform and method for servicing and facilitating providers and retailers to carry out trading activities, so as to simplify the trading processes and benefit the providers, retailers, logistic providers, consumers and the platform operator with advantages of Internet and digital technologies. The providers can be referred to as any entities providing products such as manufacturers (e.g., factories), product makers, traders, etc. The retailers can be referred to as any entities having sales channel to sell products such as Internet sellers, physical store operators and the like.

According to an embodiment of the invention, the automated trading platform includes a database, a registration processing module, a product parameter generation module, a logistic management module, a price calculation module 50, a product information display module, a transaction processing module, and an information statistic module.

In the embodiment, the database is used for storing data associated with the automated trading platform.

The registration processing module is used for processing registration procedures regarding providers, retailers and a product.

The product parameter generation module is used for generating product parameters corresponding to the product according to product information.

The logistic management module is used for generating logistic management information related to the product to conduct the logistic management of the product.

The price calculation module is used for calculating various payable and acquired amounts by different roles corresponding to the product at different time points during different sales cycles.

The product information display module is used for displaying product display information related to the product.

The transaction processing module is used for receiving various transaction requests associated with the products and processing the transaction of the products.

The information statistic module is used for generating all kinds of sales information.

The automated trading method according to another preferred embodiment of the invention includes steps of:

processing registration procedures regarding the providers, retailers and a product;

generating product parameters corresponding to the product according to product information;

generating logistic management information related to the product to conduct the logistic management of the product;

calculating various payable and acquired amounts by different roles corresponding to the product at different time points during different sales cycles;

displaying product display information related to the product;

receiving various transaction requests associated with the products and conducting the transaction of the products; and

generating all kinds of sales information.

Therefore, the automated trading platform and method according to the invention has following advantages: For logistics, the container can be integrated by groupage; air shipping and related cost can be reduced; redundant transport can be reduced; single point of delivery and shipment consolidation can be achieved; warehousing storage and sharing (State of the State) can be realized; zero inventory (fulfill pipeline theory within 6 to 10 weeks, all kinds of products in the warehouse will not exceed 10 weeks, the first in, first-out); products of different attributes are all covered, such as outlet products, fixed commodity channels, short-cycle channels, seasonal goods channels, branded products, etc.; a single shipments (spot); single box shipments (pre-purchase, quantity unlimited).

For the providers, using the automated trading platform and method has following advantages: 1. Discrete products will no longer become low-price products, since they can be sold overseas to get better prices. 2. The stock costs can be reduced and controlled. 3. Through the trading platform transaction time can be recorded, and present market information can be acquired rapidly to comprehend the market acceptance to the product, so as to adjust the product attributes in next batch of production. 4. Another sales channel is provided in addition to conventional channels. 5. The provider can have the ability to dominate selling prices and product specifications on the trading platform, and to build their CIS, brand, channel, and corporate images, etc.

For retailers such as the Internet sellers and physical store operators, using the automated trading platform has following advantages: 1. The sellers need not to go abroad or using other low-cost pathway to retrieve low-cost products. They can find the products they need through this platform. 2. The payment is due after the transaction is done, no purchase and stock cost pressure. 3. The international logistic limitation will be overcome along with spreads of warehouses worldwide. 4. The retailers can focus on their Internet marketing activities for products.

The objective of the present invention will no doubt become obvious to those of ordinary skill in the art after reading the following detailed description of the preferred embodiment, which is illustrated in following figures and drawings.

### BRIEF DESCRIPTION OF THE APPENDED DRAWINGS

The teachings of the present invention can be readily understood by considering the following detailed description in conjunction with the accompanying drawings, in which:

FIG. 1 is a functional block diagram of an automated trading platform according to an embodiment of the invention.

FIG. 2 is a line chart illustrating various payable or acquired amounts by different roles corresponding to a product.

FIG. 3 is a schematic sequence diagram depicting the pre-purchase process according to an embodiment of the invention.

FIG. 4 is a schematic sequence diagram depicting the transaction request and consequent transaction process according to an embodiment of the invention.

FIG. 5A to 5C are schematic sequence diagrams of the operation processes regarding the provider, the retailer, the logistic operators, and the automated trading platform during a sales cycle period of a product from registration in on the platform to completing a transaction.

FIG. 6 is a flow chart illustrating an automated trading method according to another preferred embodiment of the invention.

FIG. 7 is a flow chart illustrating sub-steps of step S10 in FIG. 6.

FIG. 8 is a flow chart illustrating sub-steps of step S16 in FIG. 6.

FIG. 9 is a flow chart illustrating sub-steps of step S20 in FIG. 6.

### DETAILED DESCRIPTION

The invention provides an automated trading platform and method which is used for servicing providers and retailers to carry out trading activities. In one embodiment, the providers can be referred to as any entities providing products such as manufacturers (e.g., factories), product makers, traders, etc. The retailers can be referred to as any entities having sales channel to sell products such as Internet sellers, physical store operators and the like. The features and spirits of the present invention can be readily understood by considering the following detailed description the embodiment.

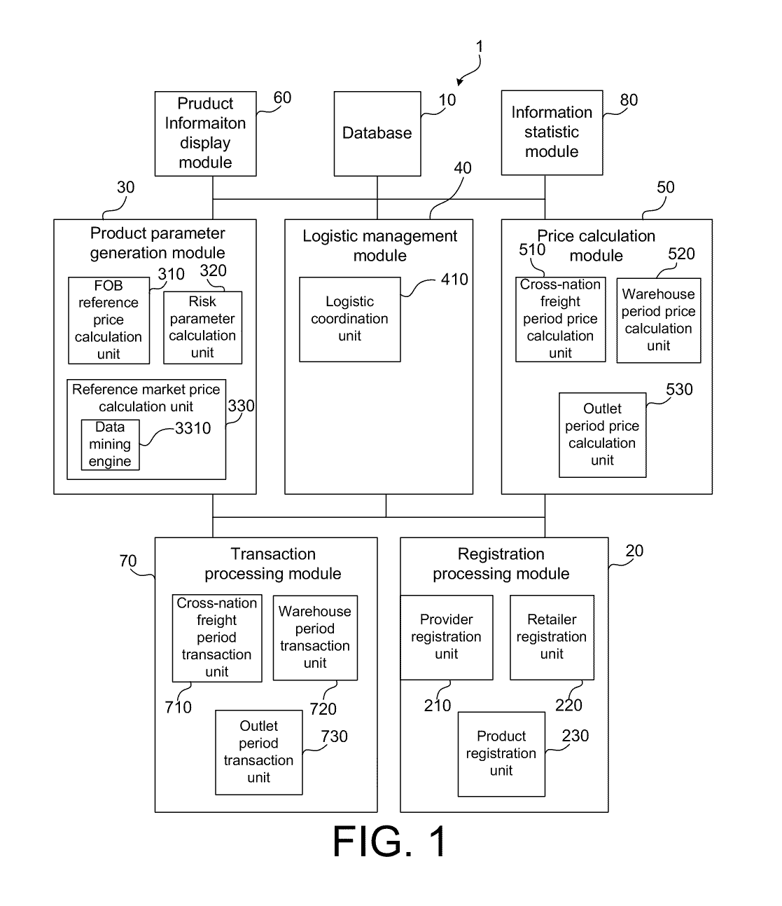

Please refer to FIG. 1. FIG. 1 is a functional block diagram of an automated trading platform 1 according to an embodiment of the invention. As shown in FIG. 1, the trading platform 1 includes a database 10, a registration processing module 20, a product parameter generation module 30, a logistic management module 40, a price calculation module 50, a product information display module 60, a transaction processing module 70, and an information statistic module 80. In practice, the automated trading platform 1 can be preferably, but not limited to, a computer mainframe, a computer-executable software, a distributed computer systems, or the like. Following description will explain the functions and features of each module of the automated trading platform 1:

The database 10 is used for storing data associated with the automated trading platform 1.

The registration processing module 20 can be used for processing registration procedures regarding providers, retailers and a product. In one embodiment, the registration processing module 20 can further include, but not limited to, a provider registration unit 210, a retailer registration unit 220 and a product registration unit 230.

In an embodiment, the provider registration unit 210 can be used for receiving a registration request and a description of the provider, and optionally conducting a registration process of the provider according to the received registration request and description of the provider.

In an embodiment, the retailer registration unit 220 can be used for receiving a registration request and a description of the retailer, and optionally conducting a registration process of the retailer according to the received registration request and description of the retailer.

In an embodiment, the product registration unit 230 can be used for receiving a registration request and a description of the product, and optionally conducting a registration process of the product according to the received registration request and description of the product.

In real applications, the product description may include, but not limited to, a product name, specifications, quantity, product image, and so on. For example, through a webpage-based user interface provided by the product registration unit, a provider can input a product description, such as a product name, specifications, quantity, upload an image or a URL where the image is stored, and transmit a registration request of the product. Alternatively, the provide can transmit the product description and the registration request through various method such as e-mails, fax, all kinds of electronic or physical documents, not limited to the webpage method.

The product parameter generation module 30 can be used for generating product parameters corresponding to the product according to the product description, wherein the product parameters can includes, but not limited to, a free on board (FOB) reference price, a risk parameter and suggested sales regions.

In the embodiment, the product parameter generation module 30 can include a FOB reference price calculation unit 310 used for calculating the FOB reference price according to a reference market price of the product using a FOB reference price algorithm. The FOB reference price herein refers to as a maximum amount the provider can acquire estimated by the platform according to the reference market price. The reference market price can be, but not limited to, generated by following reference market price calculation unit 330.

In one embodiment, the FOB reference price algorithm requires parameters such as auxiliary fees of the product (such as shipping fee, tariff, customs documents fee, warehouse fee, etc.), a discount rate and a profit rate. In other words, the FOB reference is calculated by applying the reference market price and aforesaid related parameters to the FOB reference price algorithm.

In an embodiment, the FOB reference price algorithm can calculate the FOB reference price with the equation:

(RMP*DR)=(FOBRP+SH+TA+WH+CDF)*(1+PR)

RMP is the reference market price; DR is the discount rate; FOBRP is the FOB reference price; SH is the shipping fee; TA is the tariff; WH is the warehouse fee; CDF is the Customs documents fee; and PR is the profit rate. In the algorithm, the reference market price multiplying the discount rate equals the payable amount by the retailer. The profit rate refers to as a rate of the profit acquired by the operator of the automated trading platform 1.

In an embodiment, the product parameter generation module 30 can include a reference market price calculation unit 330 for generating the reference market price. In practice, the reference market price calculation unit 330 can further include a data mining engine 3310. The data mining engine 3310 can be used for conducting data mining according to the product description, to retrieve at least one mined market price. The reference market price calculation unit 330 then generates the reference market price according to the at least one mined market price.

For instance, the data mining engine 3310 can conduct data mining in the public such as various auction websites or Internet malls according to the product description such as the product name and specifications, to retrieve market prices of comparable products as being the mined market price. Then, the reference market price calculation unit 330 utilizes certain statistic method such as average method or weighted averages method to generate the reference market price according to the mined market price. It is worth noting that since the price variation may be large in different market regions, the data mining engine 3310 can conduct data mining respectively according to sales region difference, and thereafter categorize the mined market prices.

In an embodiment, the product parameter generation module 30 can include a risk parameter calculation unit 320 for generating a risk parameter. The risk parameter can include a price of risk and a time of risk. In practice, the price of risk can be the reference market price multiplying a rate of risk, wherein the rate of risk is an experience value. The time of risk refers to as the time when the cost of returned goods corresponding to the product is larger than or equal to the price of risk. For example, the reference market price of product A is 80 Euros and the rate of risk is 20%, then its price of risk is 80 Euros*20%=16 Euros. As product A is shipped to Europe for sale, but is not sold out for 60 days since the departure date. At that time the cost of return goods corresponding to product A (including aforesaid auxiliary fees, warehouse fees and derivate fees for returning the product to its provider) equals 16 Euros, then 60 days is the time of risk of product A. The risk parameters are important reference for providers to estimate possible sales cycle time, warehouse period, and so on.

By the product parameter generation module 30, important reference information for the operator of the automated trading platform 1 and the providers, etc. is generated. On one hand the providers can grasp the FOB reference price and risk parameters, etc. of the product. On the other hand the operator of the automated trading platform 1 can assure the profit and effectively reduce the risk from logistic cost. In other word, by using the novel technology provided by the automated trading platform 1 according to the invention, the operator can lower the business risk effectively.

The logistic management module 40 can be used for generating logistic management information related to the product to conduct the logistic management of the product. For example, the logistic management information can include a shipping notice for notifying the provider of the product to send the product to a designated location such as a cargo port at a designated time. For sure the logistic management module 40 can also be used to facilitate the management of the logistic procedure of whole sales cycles of the product, such as cross-national freight, entering the warehouse, delivery to retailer designated locations, even direct delivery to end-consumer designated locations.

In one embodiment, the logistic management module 40 can further include a logistic coordination unit 410 for coordinating logistic management for a variety of products. For example, plural providers are going to sell their various products to a certain city in Europe through the automated trading platform 1 by registration, and then the logistic coordination unit 410 can conduct a logistic coordination process such as groupage on a basis of different logistic information of individual products such as product volumes, shipping date/time, product attributes, quantity of the products. Therefore, providers using the automated trading platform 1 can take advantage of groupage with other providers to reduce shipping cost and have better change to ship products of small volume and large variety.

The price calculation module 50 can be used for calculating various payable and acquired amounts by different roles corresponding to the product at different time points during different sales cycles.

In one embodiment, the price calculation module 50 can include a cross-nation freight period price calculation unit 510 for calculating, according to parameters such as a FOB upper-limit price, a FOB lower-limit price, auxiliary fees of the product(such as the shipping fee, tariff, customs documents fee), profit rate, departure date, arrival date, freight days and present date, the various payable and acquired amounts by different roles corresponding to the product at different time points during different sales cycles, such as the acquired amount by the provider, the acquired amount by the platform operator and the payable amount by the retailer. In an embodiment, the FOB upper-limit price can be equal to the FOB reference price, or can be determined by the provider of the product according to the FOB reference price, as such the FOB upper-limit price can be, but not limited to, equal to or approximate the FOB reference price. The FOB lower-limit price can be determined by the provider of the product, and the lower-limit price means the lowest sales price accepted by the provider.

It is worth noting that during the cross-nation freight period, the operator of the automated trading platform 1 can determine that the profit rate changes with time, as such the other amounts such as the payable amount by the retailer can also change with time. Therefore, during the cross-nation freight period, an opportunity is provided with which the retailer can purchase products in lower prices, so as to promote the purchase motivation.

In one embodiment, the cross-nation freight period price calculation unit can use following equations to calculate those amounts:

Acquired amount by the provider=(FOB upper-limit price+FOB lower-limit price)/2;

Acquired amount by the operator of the automated trading platform=(FOB upper-limit price−FOB lower-limit price)/2+(acquired amount by the provider+shipping fee+tariff+customs documents fee)*(estimated lowest profit rate 30 current shipping days/total shipping days*(estimated highest profit rate−estimated lowest profit rate)); and

Payable amount by the retailer=payable amount by the provider+payable amount by the operator of the automated trading platform+shipping fee+tariff+customs documents fee.

In one embodiment, the price calculation module 50 can include a warehouse period price calculation unit 520 for calculating, according to parameters such as a FOB upper-limit price, a FOB lower-limit price, auxiliary fees (e.g., shipping fee, tariff, customs documents fee), profit rate, etc., the various payable and acquired amounts by different roles corresponding to the product during the warehouse period, such as the acquired amount by the provider, the acquired amount by the platform operator and the payable amount by the retailer.

In an embodiment, the warehouse period price calculation unit 520 can use, but not limited to, the following equations to calculate the amounts:

Acquired amount by the provider=FOB upper-limit price;

Acquired amount by the operator of the automated trading platform=(acquired amount by the provider+shipping fee+tariff+customs documents fee+warehouse fee)*profit rate; and

Payable amount by the retailer=acquired amount by the provider+acquired amount by the operator of the automated trading platform+shipping fee+tariff+customs documents fee+warehouse fee.

It is worth noting that according to the warehouse period calculation, the provider can get the predetermined FOB upper-limit price to achieve highest profit.

In one embodiment, length of the storage period is related to aforesaid time of risk, it could be, but not limited to, the time of risk subtracting a buffer time.

In one embodiment, the price calculation module 50 can include an outlet period price calculation unit 530 for calculating, according to parameters such as a FOB upper-limit price, a FOB lower-limit price, auxiliary fees (e.g., shipping fee, tariff, customs documents fee), profit rate, etc., the various payable and acquired amounts by different roles corresponding to the product during the outlet period, such as the acquired amount by the provider, the acquired amount by the platform operator and the payable amount by the retailer. Outlet period refers to as the period from the end of the warehouse period to the time of risk.

In an embodiment, the outlet period price calculation unit 530 can use, but not limited to, the following equations to calculate the amounts:

Acquired amount by the provider=FOB upper-limit price−warehouse fee;

Payable amount by the retailer=discounted price; and

Acquired amount by the operator of the automated trading platform=payable amount by the retailer−(acquired amount by the provider+shipping fee+tariff+customs documents fee+warehouse fee).

It is worth noting that during outlet period the product is recognized as hard to sell, so the payable amount by the retailer goes down to be a discounted price to prompt a rapid sale of the product. The discount price can be determined by the retailer or the operator of the automated trading platform 1, or by multiplying a historical highest price with a fixed discounting rate. Besides, the warehouse fee during the outlet period is afforded by the provider.

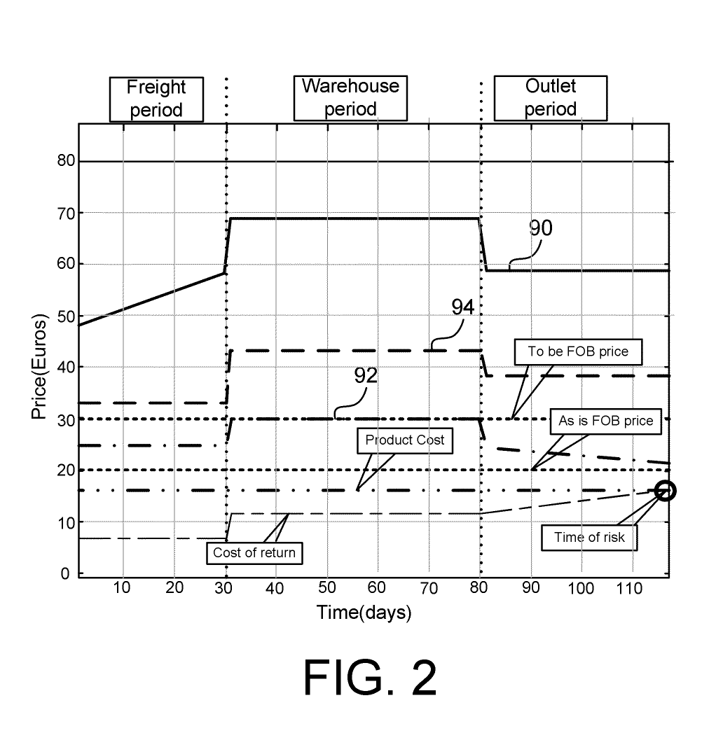

Please refer to FIG. 2. FIG. 2 is a line chart illustrating various payable or acquired amounts by different roles corresponding to the product. As shown in FIG. 2, the line 90 is the payable amount by the retailer, line 92 is the acquired amount by the provider; line 94 is the payable amount by the retailer subtracting the acquired amount by the operator of the automated trading platform 1.

By the price calculation module 50, the automated trading platform 1 can automatically calculate the various payable and acquired amounts by different roles corresponding to the product at different time points during different sales cycles, and generate corresponding analytic charts such as FIG. 2. According to the analysis and feedbacks, the operator of the automated trading platform 1, the providers, even the retailers can all acquire reasonable prices and profits at proper time point of sales of the product. Otherwise, benefits of different roles can be balanced by adjusting the algorithm according to the analyzed results.

The product information display module 60 is used for displaying product display information related to the product. In an embodiment, the product information display module 60 can, preferably but not limited to, display the product display information on a webpage.

In one embodiment, the product display information can include all or partial content of the product description, and also other related information associated with the product, such as the product status or payable amount due of the product. For example, the product display information can have a product status associated with the product such as not shipping yet, shipping, arrival, in warehouse, or so on. In practice, the product information display module 60 can also determine the displayed product display information according to authority of the viewer.

The transaction processing module 70 is used for receiving various transaction requests associated with the products and conducting the transaction of the products.

In one embodiment, the transaction processing module 70 can include a cross-nation freight period transaction unit 710 for receiving a pre-purchase request during the cross-nation freight period and optionally conducting the transaction of the product.

In one embodiment, the cross-nation freight period transaction unit 710 can optionally generate a pre-purchase confirmation according to the pre-purchase request and the payable amount by the retailer calculated in accordance with the pertinent parameters at that time. Meanwhile, the cross-nation freight period transaction unit 710 can update the pre-purchased quantity and available pre-purchase quantity of the product in the database 10, and transmit the pre-purchase confirmation to the logistic management module 40. After the end of the shipping period and before the product entering the warehouse, the logistic management module 40 can generate a shipping notice according to the pre-purchase confirmation, to notify related logistic operators to send the product to the location designated by the retailer who pre-purchased the product according to the shipping notice. Otherwise, the product can be sent into the warehouse first, and then be handled according to the decision of the retailer.

For example, a retailer such as an operator of a physical store A perceives product information of product B by the information displayed by the product information display module 60 on the automated trading platform 1, and wants to get product B with a lower price during the cross-nation freight period of product B. At the time the operator A can transmit a pre-purchase request to the platform, and then the cross-nation freight period transaction unit 710 receives the pre-purchase request and determines if the pre-purchase request is accepted according to the available pre-purchase quantity of product B. After the pre-purchase request is accepted and the operator A fulfills the payment, the operator A will receive a pre-purchase confirmation. After product B arrives, the logistic management module 40 will notify related logistic operators to send product B to the location designated by retailer A to finish the transaction. Otherwise, the product can be sent into the warehouse first, and then be handled according to the decision of the retailer. For example, product B can be sent to the location designated by retailer A after product B is sold.

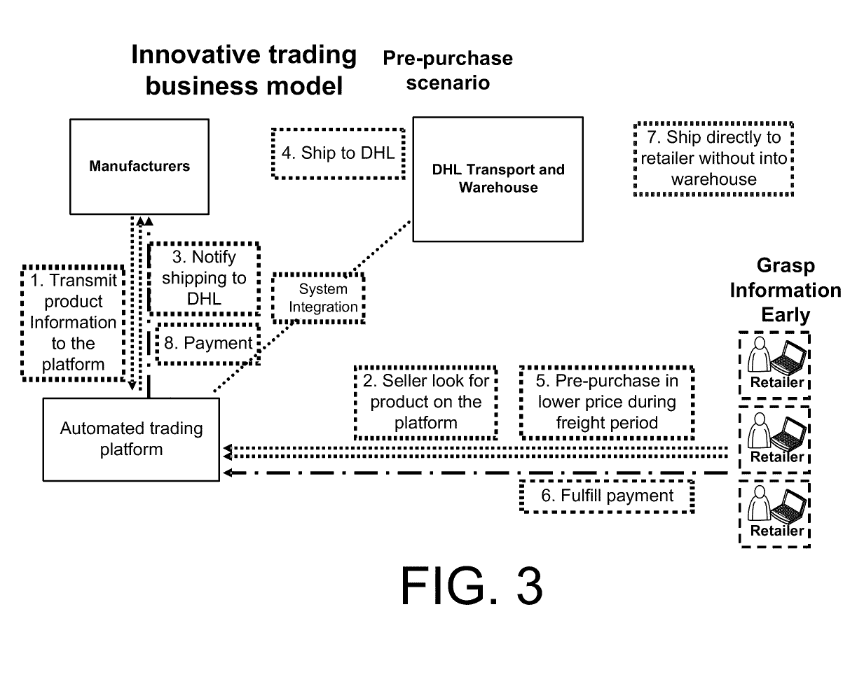

Please refer to FIG. 3. FIG. 3 is a schematic sequence diagram depicting the pre-purchase process according to an embodiment of the invention. As shown in FIG. 3, through the pre-purchase processes, the retailer can make the logistic operators to send the product directly to the designated location right after the product arrive without going into the warehouse, to finish the transaction.

By the cross-nation freight period transaction unit 710 of the transaction processing module 70, the retailer can pre-purchase the product with lower price during the cross-nation freight period, to achieve more profit from follow-up sale. The provider can sales amount earlier to achieve early profit.

In one embodiment, the transaction processing module 70 can include a warehouse period transaction unit 720 for receiving a transaction request associated with the product during the warehouse period and optionally conducting the transaction of the product.

In an embodiment, the warehouse period transaction unit 720 can optionally generate a transaction booking information according to the transaction request and the payable amount by the retailer calculated in accordance with the pertinent parameters in the warehouse period, and send the information associated with the product to the retailer. If the retailer is an Internet seller, then the retailer can then use the product information to conduct internet auction. In an embodiment, the Internet seller has to send back the URL of the online auction to the platform to complete the transaction booking process.

In one embodiment, the retailer can have certain credits used for booking products. The credits can be, but not limited to, converted from the member fee the retailer paid the operator of the platform. After the transaction booking process is finished, the warehouse period transaction unit 720 can update the booked quantity and available quantity for booking of the product, and the credits of the retailer.

As the retailer successfully sells the product and pays the payable amount, the logistic management module 40 can generate a shipping notice according to the transaction booking information, to notify related logistic operators to send the product to the location designated by the retailer who booked the product according to the shipping notice.

For example, a retailer such as an Internet seller C perceives product information of product D during the warehouse period by the information displayed by the product information display module 60 on the automated trading platform 1. At the time the Internet seller C can transmit a transaction booking request to the platform, and then the warehouse period transaction unit 720 receives the transaction booking request and determines if the transaction booking request is accepted according to the available booking quantity of product B. After the transaction booking request is accepted, the operator A will receive product information associated with product D which can be used for conducting the Internet auction. After the Internet seller C successfully sell product D to an Internet buyer E, the Internet buyer E pays Internet seller C and Internet seller C pays the payable amount to the platform, the logistic management module 40 will notify related logistic operators to send product D to the location designated by retailer C, i.e. the place of Internet buyer E, to finish the transaction.

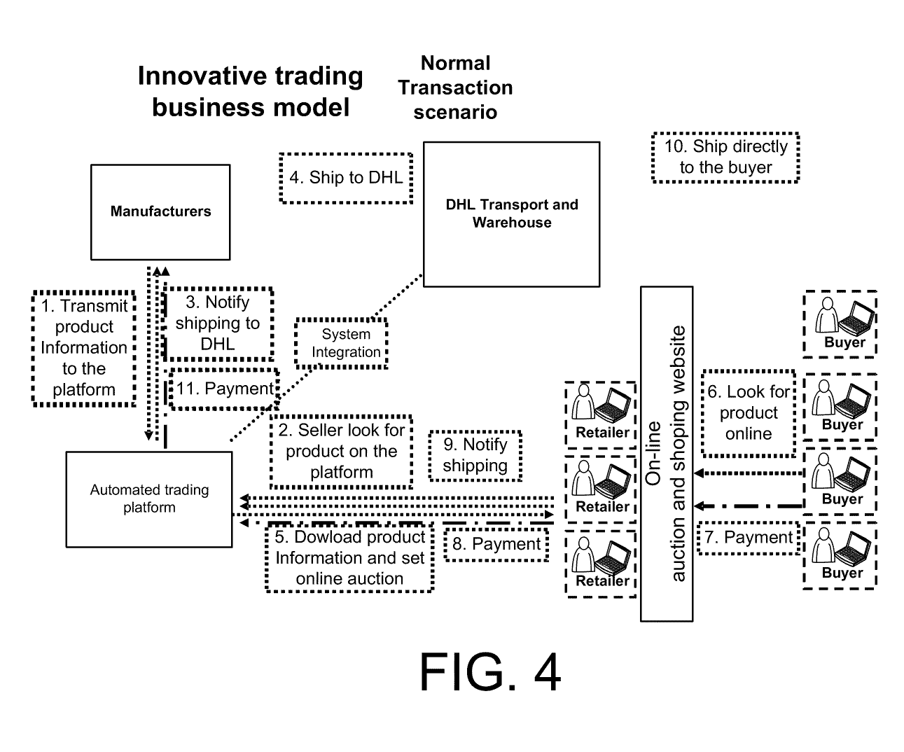

Please refer to FIG. 4. FIG. 4 is a schematic sequence diagram depicting the transaction request and consequent transaction process according to an embodiment of the invention.

By the warehouse period transaction unit 720 of the transaction processing module 70, the retailer such as an Internet seller can make a transaction booking of the product, and then conduct the online auction of the product if the booking is confirmed. After the product is sold the product can directly be shipped to the Internet buyer by logistic operators. Therefore, the complete services regarding supply of goods, information flow, logistic, etc. are all provided by the automated trading platform 1. It is very beneficial for the Internet seller. Additionally, the waste of redundant shipping can also be diminished. Even different products sold by different sellers can be integrated and shipped together.

In one embodiment, the transaction processing module 70 can include an outlet period transaction unit 730 for receiving a purchase request associated with the product during the outlet period and optionally conducting the purchase request of the product and follow-up purchase process.

In one embodiment, the outlet period transaction unit 730 can optionally generate a purchase confirmation according to the purchase request and the payable amount by the retailer calculated in accordance with the pertinent parameters in the outlet period. Meanwhile, the outlet period transaction unit 730 can update the purchased quantity and available purchase quantity of the product in the database 10, and transmit the purchase confirmation to the logistic management module 40. After the retailer fulfills the payment, the logistic management module 40 can generate a shipping notice according to the purchase confirmation, to notify related logistic operators to send the product to the location designated by the retailer who pre-purchased the product according to the shipping notice. Otherwise, the product can be into the warehouse first, and then be handled according to the decision of the retailer. For example, the product can be sent to the location designated by the retailer after the product is sold.

For example, retailer F perceives product information of product G by the information during the outlet period displayed by the product information display module 60 on the automated trading platform 1, and wants to get product G with a lower price during the outlet period. At the time the retailer A can transmit a purchase request to the platform, then the outlet period transaction unit 730 receives the purchase request and determines if the purchase request is accepted according to the purchase request and available purchase quantity of product G. After the purchase request is accepted, the retailer F will receive a purchase confirmation. After retailer F fulfills the payment, the logistic management module 40 will notify related logistic operators to send product G to the location designated by retailer F to finish the transaction. Otherwise, the product G can be sent into the warehouse first, and then be handled according to the decision of the retailer. For example, product G can be sent to the location designated by retailer F after product G is sold.

By the outlet period transaction unit 730 of the transaction processing module 70, the retailer can purchase the product with lower price during the outlet period of the product to gain more sales profit. Additionally, the provider can also acquire the sales amount after long low-selling to avoid bigger loss.

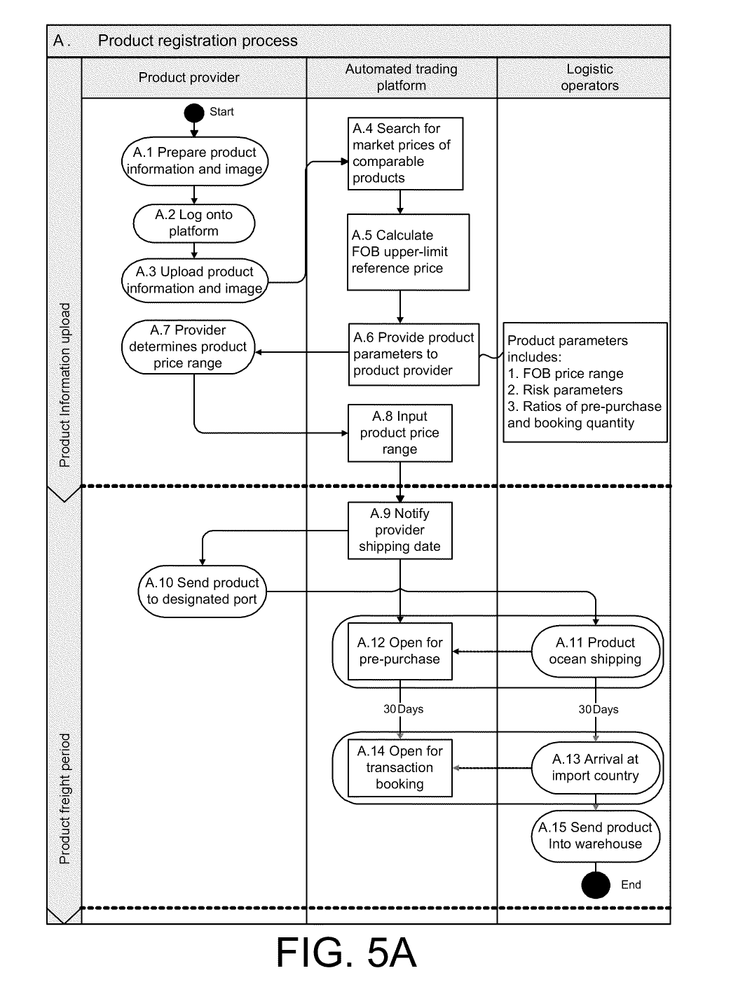

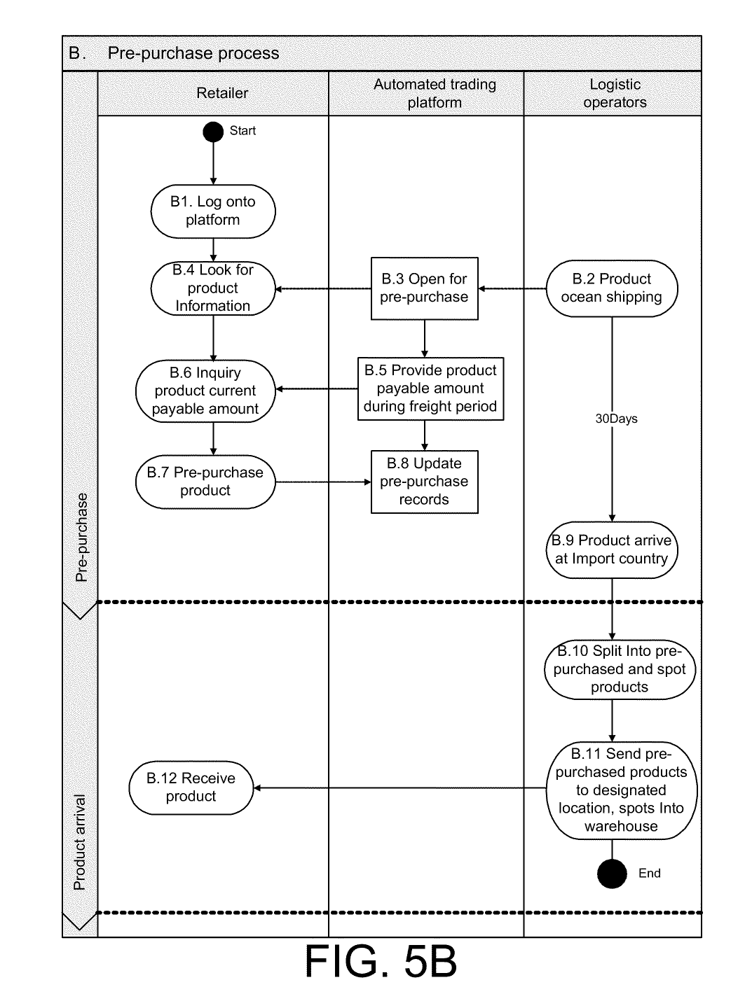

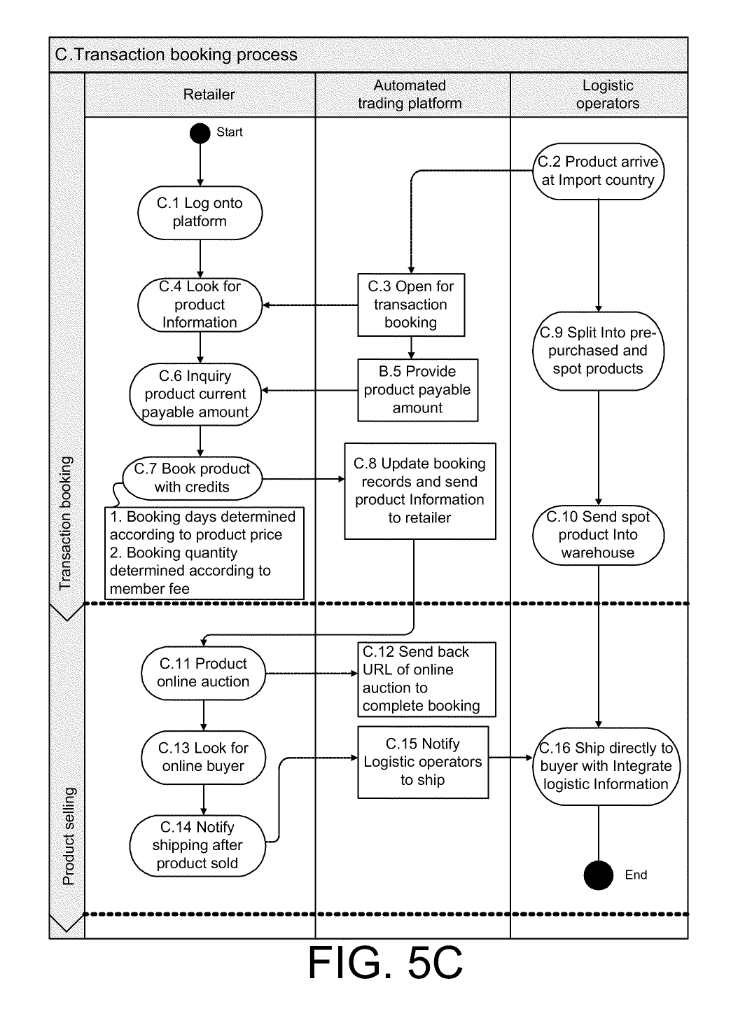

Please refer to FIG. 5A to 5C. FIG. 5A to 5C are schematic sequence diagrams of the operation processes regarding the provider, the retailer, the logistic operators, and the automated trading platform 1 during a sales cycle period of a product from registration in on the platform to conducting a transaction. In other words, FIG. 5A to 5C shows individual processes operated by the provider, the retailer, the logistic operators, and the automated trading platform 1 during the product sales cycles in a sequence diagram format.

In summary, by the transaction processing module 70, the product can be sold with different sales strategies during different sales period. With collaboration with the price calculation module 50, the transaction processing module 70 can realize maximum profits for the providers, the retailers and the operator of the automated trading platform 1.

In practice, various products provided by different providers can be sent into the same warehouse together. As different retailers sell products to the same end-consumer, by the information integration of the transaction processing module 70 and collaboration with the logistic management module 40, the automated trading platform 1 can even deliver various products bought by the same consumer from different retailers to the location designated by the consumer, to prevent waste of redundant deliveries.

In real applications, if a product can not be sold out after the freight period, the warehouse period and the outlet period, it can be handled by following methods: 1. Return the product to the provider who pays the return cost; 2. The provider affords additional charge (such as the shipping fee, tariff, customs documents fee, warehouse fee, etc.) and transfer cost, to transfer the product to another market region for sale; 3. The provider authorizes the platform to auction the product in low price and get the difference between the sales amount and the platform operation cost. 4. The provider abandons the product, and the product is auctioned by the platform whose operator solely bears the profit and loss.

The information statistic module 80 is used for generating all kinds of sales information.

In one embodiment, the information statistic module 80 can generate, according to the sales records of a product, certain statistic data such as the average sales period, the average sales price, the average sales cycle, etc. associated with the product. And the statistic data can be categorized according to sales regions, product grades, providers, etc. For providers, the statistic sales information is very precious. They can be important reference for adjusting next pre-purchase ratio during cross-nation freight period, shipping quantity, selling price, even try order, etc. With complete and precise sales information, the stock cost of the provider, the retailer and even the logistic operators can be effectively reduced.

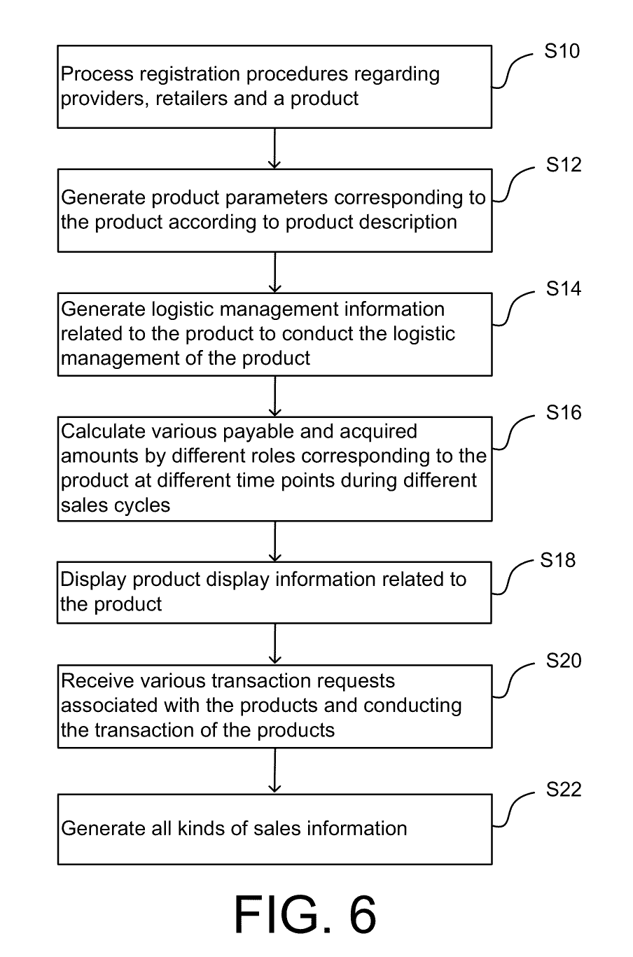

Please refer to FIG. 6. FIG. 6 is a flow chart illustrating an automated trading method according to another preferred embodiment of the invention. As shown in FIG. 6, according to another preferred embodiment of the invention, an automated trading method which is preferably applied in above-mentioned automated trading platform 1, can include following steps of:

Step S10: processing registration procedures regarding providers, retailers and a product;

Step S12: generating product parameters corresponding to the product according to product description, wherein the parameters can include, but not limited to, a FOB reference price, a risk parameter and suggested sales regions, etc.

Step S14: generating a logistic management information related to the product to conduct the logistic management of the product;

Step S16: calculating various payable and acquired amounts by different roles corresponding to the product at different time points during different sales cycles;

Step S18: displaying product display information related to the product;

Step S20: receiving various transaction requests associated with the products and conducting the transaction of the products; and

Step S22: generating all kinds of sales information.

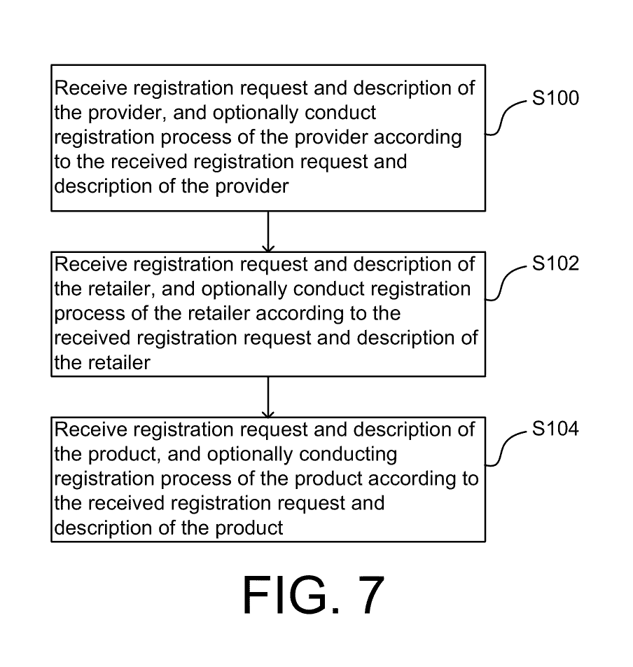

Please refer to FIG. 7. FIG. 7 is a flow chart illustrating sub-steps of step S10 in FIG. 6. As shown in FIG. 7, in one embodiment, the step S10 of processing registration procedures regarding providers, retailers and a product can include following sub-steps:

Step S100: receiving a registration request and a description of the provider, and optionally conducting a registration process of the provider according to the received registration request and description of the provider;

Step S102: receiving a registration request and a description of the retailer, and optionally conducting a registration process of the retailer according to the received registration request and description of the retailer; and

Step S104: receiving a registration request and a description of the product, and optionally conducting a registration process of the product according to the received registration request and description of the product.

In one embodiment, the step S12 of generating product parameters corresponding to the product according to the product information can further include following sub-step of:

calculating the FOB reference price according to a reference market price of the product using a FOB reference price algorithm.

In one embodiment, the automated trading method can include a step of generating a reference market price which includes following sub-steps of:

conducting data mining according to the product description, to retrieve at least one mined market price; and

generating the reference market price according to the at least one mined market price.

In one embodiment, the step of generating a product parameter corresponding to the product according to the product information can further include a step of generating a risk parameter, wherein the risk parameter can include a price of risk and a time of risk.

In practice, the step of generating logistic management information of the product can include a sub-step of coordinating logistic management for variety of products.

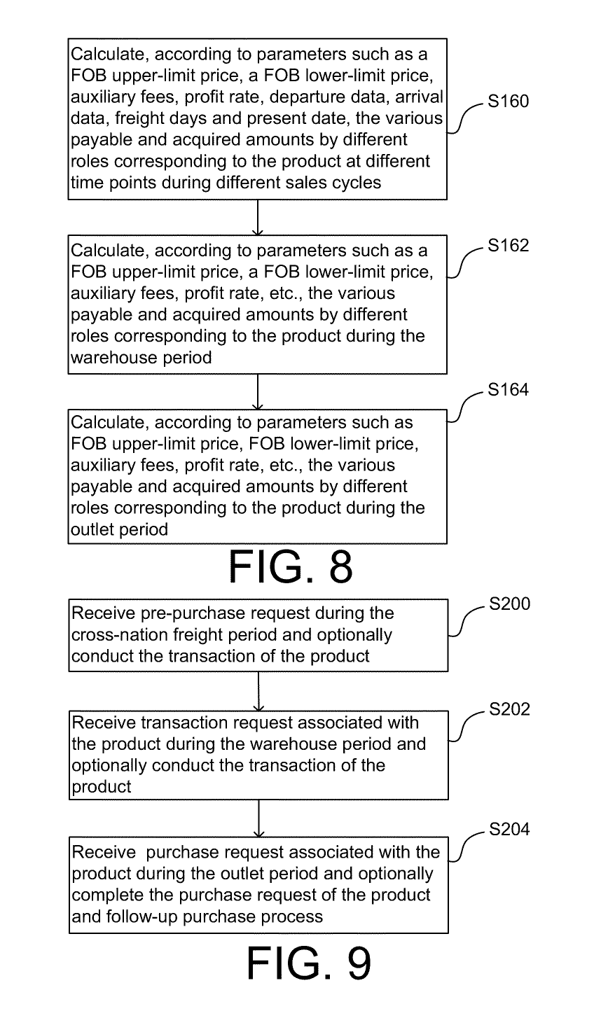

Please refer to FIG. 8. FIG. 8 is a flow chart illustrating sub-steps of step S16 in FIG. 6. As shown in FIG. 8, in one embodiment, the step S16 of calculating various payable and acquired amounts by different roles corresponding to the product at different time points during different sales cycles can further include following sub-steps of:

Step S160: calculating, according to parameters such as a FOB upper-limit price, a FOB lower-limit price, auxiliary fees (e.g., shipping fee, tariff, customs documents fee), profit rate, departure date, arrival date, freight days and present date, the various payable and acquired amounts by different roles corresponding to the product at different time points during different sales cycles, such as the acquired amount by the provider, the acquired amount by the platform operator and the payable amount by the retailer;

Step S162: calculating, according to parameters such as a FOB upper-limit price, a FOB lower-limit price, auxiliary fees (e.g., shipping fee, tariff, customs documents fee), profit rate, etc., the various payable and acquired amounts by different roles corresponding to the product during the warehouse period, such as the acquired amount by the provider, the acquired amount by the platform operator and the payable amount by the retailer; and

Step S164: calculating, according to parameters such as a FOB upper-limit price, a FOB lower-limit price, auxiliary fees (e.g., shipping fee, tariff, customs documents fee), profit rate, etc., the various payable and acquired amounts by different roles corresponding to the product during the outlet period, such as the acquired amount by the provider, the acquired amount by the platform operator and the payable amount by the retailer.

In one embodiment, the step of displaying the product display information associated with the product can include a sub-step of displaying the product display information on a webpage.

Please refer to FIG. 9. FIG. 9 is a flow chart illustrating sub-steps of step S20 in FIG. 6. As shown in FIG. 9, in one embodiment, the step S20 of receiving various transaction requests associated with the products and conducting the transaction of the products can include following sub-steps of:

Step S200: receiving a pre-purchase request during the cross-nation freight period and optionally conducting the transaction of the product;

Step S202: receiving a transaction request associated with the product during the warehouse period and optionally conducting the transaction of the product; and

Step S204: receiving a purchase request associated with the product during the outlet period and optionally completing the purchase request of the product and follow-up purchase process.

In one embodiment, the step of generating all kinds of sales information can further include the sub-step of generating, according to the sales records of a product, certain statistic data such as the average sales period, the average sales price, the average sales cycle, etc. associated with the product.

Detailed embodiments and real applications are disclosed in above automated trading platform descriptions, which are not addressed repeatedly.

Compared with prior art, the automated trading platform and method according to the invention has following advantages: For the retailers, they can save shipping fees, warehouse fees, stock cost, management cost, etc. The platform creates new opportunities from the service angle of view. For inexperienced Internet sellers, using the automated trading platform and method can help them easily become professional Internet seller. They do not have to go abroad or using other pathway to retrieve products, they can find the products they need directly on this platform. Additionally, the payment is due after the transaction is finished, with no purchase and stock cost pressure. The international logistic limitation will be overcome along with spreads of warehouses worldwide, and the retailers can focus on their internet marketing activities for products to produce more advantages and profits.

For providers, using the automated trading platform and method can give them integrated sales information and precise and complete advices, to help them to gain more profit, to manage their products, to innovate their products, and to promote their value and competence. Furthermore, discrete products will no longer become low-price products, since they can be sold overseas to get better prices. The stock costs can be reduced and controlled. Through the trading platform transaction time can be recorded, and present market information can be acquired rapidly to comprehend the market acceptance to the product, so as to adjust the product attributes in next batch of production. Another sales channel is provided in addition to conventional channels. Therefore, the providers have the ability to dominate selling prices and product specifications on the trading platform, and to build their CIS, brand, channel, and corporate images, etc.

Under the architecture of the automated trading platform and method, the niche market also can work well. The platform can easily retrieve international market price and positioning with inputted product name, description, key words, etc. The providers willing to cooperate can have their stocked products, products out of season and even small quantity of popular products integrated and be shipped to warehouses in overseas regions such as Europe or America through professional logistic and storage systems. Meanwhile, the product information can be transmitted to professional sellers who sell the same or similar products, such as Internet sellers. Additionally, the international Internet sellers can pre-purchase the products and sell the product online in advance, as such they can have lower purchase and stock cost pressure. Therefore, desire to buy can be increased to promote the sales and profits along with the sales cycle time reduced. In summary, the automated trading platform and method according to the invention can provide the providers, the logistic operators, the retailers such as Internet sellers, the Internet buyers, and the operator of the platform very good opportunities to produce win-win blue oceanic business model.

With the example and explanations above, the features and spirits of the embodiments of the invention are described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An automated trading platform, comprising:
a database, for storing data associated with the automated trading platform;
a registration processing module, for processing registration procedures regarding providers, retailers and a product;
a product parameter generation module, for generating product parameters corresponding to the product according to product information;
a price calculation module, for calculating various payable and acquired amounts by different roles corresponding to the product at different time points during different sales cycles;
a product information display module, for displaying product display information related to the product; and
a transaction processing module, for receiving various transaction requests associated with the product and processing the transaction of the product.

2. The automated trading platform of claim 1, wherein the product parameters comprise a FOB reference price and a risk parameter.

3. The automated trading platform of claim 1, wherein the a price calculation module calculates, according to parameters of a FOB upper-limit price, a FOB lower-limit price, auxiliary fees of the product, a profit rate, departure date, arrival date, freight days and present date, the various payable and acquired amounts by different roles corresponding to the product at different time points during different sales cycles.

4. The automated trading platform of claim 1, wherein the different sales cycles comprise a cross-nation freight period, a warehouse period and an outlet period, the various payable and acquired amounts by different roles corresponding to the product comprise an acquired amount by the provider, an acquired amount by the platform operator and a payable amount by the retailer.

5. The automated trading platform of claim 1, further comprises a logistic management module for generating logistic management information related to the product to conduct a logistic management of the product.

6. The automated trading platform of claim 4, wherein the logistic management module generates integrated logistic management information according to information integration of the transaction processing module.

7. The automated trading platform of claim 1, further comprises an information statistic module for generating all kinds of sales information.

8. The automated trading platform of claim 7, wherein the information statistic module generates, according to the sales records of a product, statistic data of the average sales period, the average sales price and the average sales cycle associated with the product, the statistic data being categorized according to sales regions, product grades and providers.

9. An automated trading method, applied in an automated trading platform, data associated with the automated trading platform being previously stored, said automated trading method comprising:
(a) processing a registration procedure regarding a provider;
(b) processing a registration procedures regarding a retailer;
(c) processing a registration procedures regarding a product;
(d) generating product parameters corresponding to the product according to product information;
(e) calculating various payable and acquired amounts by different roles corresponding to the product at different time points during different sales cycles;
(f) displaying product display information related to the product;
(g) receiving various transaction requests associated with the product; and
(h) conducting the transaction of the product.

10. The automated trading platform of claim 1, wherein the product parameters comprise a FOB reference price and a risk parameter.

11. The automated trading method of claim 9, wherein step (e) calculates, according to parameters of a FOB upper-limit price, a FOB lower-limit price, auxiliary fees of the product, a profit rate, departure date, arrival date, freight days and present date, the various payable and acquired amounts by different roles corresponding to the product at different time points during different sales cycles.

12. The automated trading method of claim 9, wherein the different sales cycles comprise a cross-nation freight period, a warehouse period and an outlet period, the various payable and acquired amounts by different roles corresponding to the product comprise an acquired amount by the provider, an acquired amount by the platform operator and a payable amount by the retailer.

13. The automated trading method of claim 9, further comprises the step of generating logistic management information related to the product to conduct the logistic management of the product.

14. The automated trading method of claim 9, further comprises the step of generating all kinds of sales information.
